(19) United States
(12) Patent Application Publication
(10) Pub. No.: US 2024/0210073 A1
(43) Pub. Date: Jun. 27, 2024

(54) ABSORBER UNIT FOR ABSORPTION REFRIGERATOR, HEAT EXCHANGE UNIT, AND ABSORPTION REFRIGERATOR

(71) Applicant: Panasonic Intellectual Property Management Co., Ltd., Kadoma-shi, Osaka (JP)

(72) Inventors: Hongzhi SUN, Osaka (JP); Bunki KAWANO, Osaka (JP); Nobukazu SHIMODAHIRA, Osaka (JP); Masaru MATSUI, Kyoto (JP)

(21) Appl. No.: 18/556,021

(22) PCT Filed: Feb. 10, 2022
(86) PCT No.: PCT/JP2022/005256

§ 371 Date: Oct. 18, 2023

(30) Foreign Application Priority Data
Apr. 19, 2021 (JP) 2021-070480

(51) Int. Cl. F25B 15/00; F25B 37/00

(52) U.S. Cl. CPC F25B 15/006; F25B 37/00; F25B 2315/002

(57) ABSTRACT

An absorber unit 1a includes a first absorber 13a and a second absorber 13b. The first absorber 13a includes a first heat transfer tube group 11a and a first dripper 12a. The second absorber 13b includes a second heat transfer tube group 11b and a second dripper 12b. The first heat transfer tube group 11a has a first end portion 11m, and the second heat transfer tube group 11b has a second end portion 11n. In the first end portion 11m and the second end portion 11n, a shortest distance D1 is larger than a shortest distance D2. The shortest distance D1 is a shortest distance, in a gravity direction, between the outer surfaces of a specific pair of heat transfer tubes 10 adjacent to each other in the first end portion 11m. The shortest distance D2 is a shortest distance, in the gravity direction, between the outer surfaces of a pair of heat transfer tubes 10 in the second end portion 11n that form rows corresponding to the specific pair of heat transfer tubes 10.

### TECHNICAL FIELD

The present disclosure relates to an absorber unit for an absorption refrigerator, a heat exchange unit, and an absorption refrigerator.

### BACKGROUND ART

Absorption refrigerators are conventionally known. For example, Patent Literature 1 describes an absorption heat pump device. This absorption heat pump device includes an evaporator, an absorber, a condenser, a high-temperature regenerator, and a low-temperature regenerator. The evaporator and the absorber are configured to have a two-stage evaporation/absorption structure in which each of the evaporator and the absorber is arranged in two stages. The evaporator is divided into a first evaporator (higher-stage evaporator) and a second evaporator (lower-stage evaporator) by a partition.

The absorber is divided into a first absorber (higher-stage absorber) and a second absorber (lower-stage absorber) by a partition. This partition is provided with a solution sprinkling device that collects a solution having flowed down the second absorber, and sprinkles the solution toward the first absorber. The first evaporator and the first absorber communicate with each other such that a refrigerant vapor flows through an eliminator, and the second evaporator and the second absorber also communicate with each other such that a refrigerant vapor flows through an eliminator.

The solution concentrated by the high-temperature regenerator and the low-temperature regenerator is sprinkled from the solution sprinkling device disposed in an upper portion of the second absorber, and absorbs the refrigerant vapor generated in the second evaporator, while flowing down the second absorber. Heat of absorption heats hot water flowing in the absorber. The solution whose concentration is reduced due to absorption of the refrigerant vapor is collected into the solution sprinkling device disposed on the partition, and is sprinkled toward the first absorber. The sprinkled solution absorbs the refrigerant vapor generated in the first evaporator, while flowing down the first absorber, and heat of absorption heats hot water flowing in the absorber. The diluted solution whose concentration is further reduced due to absorption of the refrigerant vapor is temporarily stored in a lower portion of the first absorber, and thereafter is sent to the high-temperature regenerator and the low-temperature regenerator.

### CITATION LIST

### Patent Literature

Patent Literature 1: JP 2012-202589 A

### SUMMARY OF INVENTION

### Technical Problem

The present disclosure provides an absorber unit, for an absorption refrigerator, which is advantageous in terms of inhibiting a state in which heat transfer tubes are not wet with an absorbent liquid, while including a plurality of absorbers.

### Solution to Problem

An absorber unit for an absorption refrigerator according to the present disclosure includes:
a first absorber being provided with a first heat transfer tube group including a plurality of heat transfer tubes arranged in rows and columns, and a first dripper configured to drip an absorbent liquid toward the first heat transfer tube group, the first absorber allowing the absorbent liquid dripped by the first dripper to absorb a vapor-phase refrigerant that is supplied to one end, in a column direction, of the first heat transfer tube group; and
a second absorber being provided with a second heat transfer tube group including a plurality of heat transfer tubes arranged in rows and columns, and a second dripper configured to drip an absorbent liquid toward the second heat transfer tube group, the second absorber allowing the absorbent liquid dripped by the second dripper to absorb a vapor-phase refrigerant that is supplied to one end, in the column direction, of the second heat transfer tube group, wherein
the absorbent liquid that has been dripped by the first dripper and has flowed down the first heat transfer tube group is supplied to the second absorber and then is dripped by the second dripper,
the absorbent liquid that has been dripped by the second dripper and has flowed down the second heat transfer tube group is discharged to the outside of the second absorber,
the first heat transfer tube group has a first end portion that includes the heat transfer tubes forming the rows, at the one end, in the column direction, of the first heat transfer tube group,
the second heat transfer tube group has a second end portion that includes the heat transfer tubes forming the rows, at the one end, in the column direction, of the second heat transfer tube group, and
a shortest distance, in a gravity direction, between outer surfaces of a specific pair of the heat transfer tubes adjacent to each other in the first end portion is larger than a shortest distance, in the gravity direction, between outer surfaces of a pair of the heat transfer tubes forming, in the second end portion, rows corresponding to the specific pair of the heat transfer tubes.

### Advantageous Effects of Invention

According to the absorber unit for an absorption refrigerator of the present disclosure, since the shortest distance, in the gravity direction, between the outer surfaces of the specific pair of the heat transfer tubes is relatively large, the flow velocity of the vapor-phase refrigerant passing through the gap between the outer surfaces of the specific pair of the heat transfer tubes is less prone to be increased. Therefore, when the absorbent liquid flows down the first heat transfer tube group, the absorbent liquid is less prone to be blown off by the vapor-phase refrigerant, thereby inhibiting the state in which the heat transfer tubes in the first heat transfer tube group are not wet with the absorbent liquid.

### BRIEF DESCRIPTION OF THE DRAWINGS

FIG. 1 shows a heat exchange unit according to Embodiment 1.

FIG. 2 shows an absorption refrigerator according to Embodiment 2.

### DESCRIPTION OF EMBODIMENTS

### Findings on which the Present Disclosure is Based

At the time when the present inventors conceived of the present disclosure, an absorption refrigerator having a two-stage evaporation/absorption structure in which each of an evaporator and an absorber was provided in two stages, was known. In such an absorption refrigerator, a difference in concentration between a concentrated absorbent liquid and an absorbent liquid whose concentration is reduced due to absorption of a vapor-phase refrigerant is increased, and therefore, it is considered that reduction in the circulation amount of the absorbent liquid can be achieved. As a result, it is considered that efficiency of heat exchange in the absorber tends to be increased, and the absorption refrigerator tends to exhibit a high COP.

Meanwhile, in the technical field of absorption refrigerators, generally, heat transfer tubes of heat transfer tube groups were similarly designed and arranged in a low pressure side absorber and a high pressure side absorber, due to restrictions on the size of a shell that contains heat exchangers such as absorbers. Under such a situation, the present inventors have come up with an idea that down-sizing of an absorber unit is achieved by increasing the density of heat output from the absorber by utilizing the large difference in concentration between the concentrated absorbent liquid and the absorbent liquid whose concentration is reduced due to absorption of the vapor-phase refrigerant. The present inventors have found that, in realizing the idea, the absorbent liquid, which flows down the heat transfer tube group in the low pressure side absorber, tends to be blown off by the vapor-phase refrigerant, which may cause a state in which the heat transfer tubes are not wet with the absorbent liquid. If the heat transfer tubes are not wet with the absorbent liquid in the absorber, efficiency of heat exchange of the absorber is significantly degraded.

Consideration is now given to an absorber unit configured such that the concentrated absorbent liquid is supplied to the low pressure side absorber, and the absorbent liquid whose concentration is reduced due to absorption of the vapor-phase refrigerant is discharged from the high pressure side absorber. In such an absorber unit, a logarithmic mean temperature difference (LMTD) in the low pressure side absorber is larger than the LMTD in the high pressure side absorber. Each LMTD is determined based on the temperature of the absorbent liquid that flows down the heat transfer tube group, and on the temperature of a heat medium that flows inside the heat transfer tubes in the heat transfer tube group. When the logarithmic mean temperature difference (LMTD) in the low pressure side absorber is larger than the LMTD in the high pressure side absorber, the amount of the vapor-phase refrigerant to be absorbed by the absorbent liquid around the heat transfer tubes in the heat transfer tube group of the low pressure side absorber, tends to be increased. Therefore, the mass flow rate of the vapor-phase refrigerant tends to be increased around the heat transfer tubes in the low pressure side absorber. In addition, since the pressure in the low pressure side absorber is lower than the pressure in the high pressure side absorber, the density of the vapor-phase refrigerant to be absorbed by the absorbent liquid in the low pressure side absorber is lower than the density of the vapor-phase refrigerant to be absorbed by the absorbent liquid in the high pressure side absorber. Therefore, the volume flow rate of the vapor-phase refrigerant tends to be increased around a specific heat transfer tube in the low pressure side absorber. As a result, the flow velocity of the vapor-phase refrigerant that flows through the heat transfer tube group of the low pressure side absorber is increased, and the absorbent liquid, which flows down the heat transfer tube group in the low pressure side absorber, tends to be blown off by the vapor-phase refrigerant, which may result in the above-described problem. In order to solve the above-described problem, the present inventors arrived at configuring the subject of the present disclosure.

Thus, the present disclosure provides an absorber unit for an absorption refrigerator that is advantageous in terms of inhibiting the state in which the heat transfer tubes are not wet with the absorbent liquid, while including a plurality of absorbers.

Embodiments will be described in detail below with reference to the drawings. However, an unnecessarily detailed description may be omitted. For example, a detailed description of the matters already well known and a repeated description of substantially the same configuration may be omitted. This is to avoid the following description from being unnecessarily redundant and to facilitate the understanding of a person skilled in the art. Note that the accompanying drawings and the following description are provided for those skilled in the art to fully understand the present disclosure, and thus are not intended to limit the subject matters recited in the claims to these.

### Embodiment 1

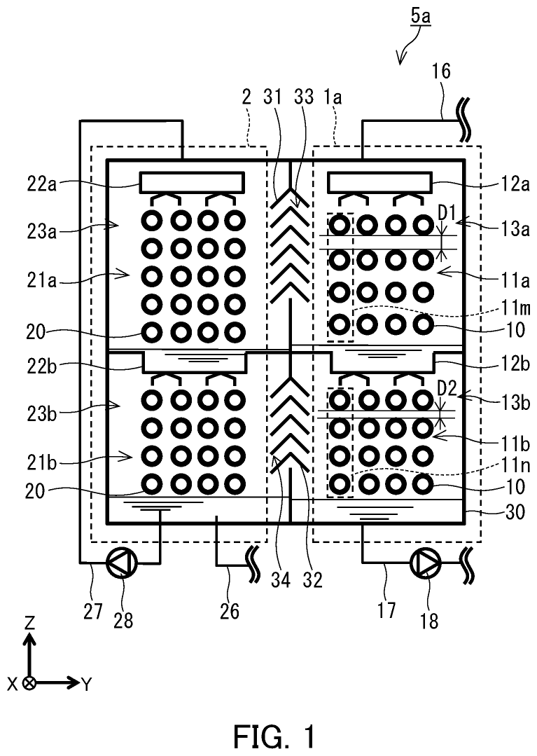

Embodiment 1 will be described with reference to FIG. 1. In the accompanying drawings, the Z-axis negative direction represents the gravity direction. The X-axis, the Y-axis, and the Z-axis are orthogonal to each other.

### 1-1. Configuration

As shown in FIG. 1, an absorber unit 1a for an absorption refrigerator includes a first absorber 13a and a second absorber 13b. Each of the first absorber 13a and the second absorber 13b is, for example, a shell-and-tube heat exchanger. The first absorber 13a includes a first heat transfer tube group 11a, and a first dripper 12a. The first heat transfer tube group 11a includes heat transfer tubes 10 arranged in rows and columns. The first dripper 12a drips an absorbent liquid toward the first heat transfer tube group 11a. The first absorber 13a allows the absorbent liquid dripped by the first dripper 12a to absorb a vapor-phase refrigerant supplied to one end, in the column direction, of the first heat transfer tube group 11a. The second absorber 13b includes a second heat transfer tube group 11b, and a second dripper 12b. The second heat transfer tube group 11b includes heat transfer tubes 10 arranged in rows and columns. The second dripper 12b drips the absorbent liquid toward the second heat transfer tube group 11b. The second absorber 13b allows the absorbent liquid dripped by the second dripper 12b to absorb the vapor-phase refrigerant supplied to one end, in the column direction, of the second heat transfer tube group 11b. The absorbent liquid, which has been dripped by the first dripper 12a and has flowed down the first heat transfer tube group 11a, is supplied to the second absorber 13b and then is dripped by the second dripper 12b. The absorbent liquid, which has been dripped by the second dripper 12b and has flowed down the second heat transfer tube group 11b, is discharged to the outside of the second absorber 13b.

The first heat transfer tube group 11a has a first end portion 11m. The first end portion 11m includes the heat transfer tubes 10 that form a plurality of rows at one end, in the column direction, of the first heat transfer tube group 11a. The second heat transfer tube group 11b has a second end portion 11n. The second end portion 11n includes the heat transfer tubes 10 that form a plurality of rows at one end, in the column direction, of the second heat transfer tube group 11b. As shown in FIG. 1, in the first end portion 11m and the second end portion 11n, a shortest distance D1 is larger than a shortest distance D2. The shortest distance D1 is a shortest distance, in the gravity direction, between the outer surfaces of a specific pair of heat transfer tubes 10 adjacent to each other in the first end portion 11m. The shortest distance D2 is a shortest distance, in the gravity direction, between the outer surfaces of a pair of heat transfer tubes 10 that form, in the second end portion 11n, rows corresponding to the specific pair of heat transfer tubes 10. Here, corresponding rows mean rows having the same row number from the uppermost row.

As long as the shortest distance D1 is larger than the shortest distance D2, the ratio of the shortest distance D1 to the shortest distance D2 is not limited to a specific value. This ratio may be in a range from 1.5 to 2.5, or from 1.5 to 2.0, for example.

The arrangement of the first absorber 13a and the second absorber 13b in the absorber unit 1a is not limited to a specific arrangement. As shown in FIG. 1, for example, the first absorber 13a is disposed in the upper stage of the absorber unit 1a, and the second absorber 13b is disposed in the lower stage of the absorber unit 1a, with reference to the gravity direction.

The position of the specific pair of heat transfer tubes 10 with the shortest distance D1 in the first end portion 11m is not limited to a specific position as long as the paired heat transfer tubes 10 are adjacent to each other in the first end portion 11m. As shown in FIG. 1, for example, the specific pair of heat transfer tubes 10 with the shortest distance D1 includes the heat transfer tubes 10 that are arranged above a center, based on the number of rows, of the first end portion 11m. For example, if the number of rows in the first end portion 11m is 2n or 2n+1, at least one of the paired heat transfer tubes 10 with the shortest distance D1 includes any one of the heat transfer tubes 10 from the uppermost row to the n-th row in the first end portion 11m. Here, n is an integer not less than 1.

As shown in FIG. 1, the specific pair of heat transfer tubes 10 with the shortest distance D1 includes, for example, the uppermost-row heat transfer tube 10 in the first end portion 11m.

As long as the shortest distance D1 is larger than the shortest distance D2, the shortest distance, in the gravity direction, between the outer surfaces of the adjacent heat transfer tubes 10 is not limited to a specific value, in each of the first end portion 11m and the second end portion 11n. As shown in FIG. 1, for example, heat transfer tubes 10 are arranged at equal intervals in the gravity direction in the first end portion 11m. In addition, heat transfer tubes are arranged at equal intervals in the gravity direction in the second end portion 11n. The shortest distance, in the gravity direction, between the outer surfaces of the adjacent heat transfer tubes 10 in the first end portion 11m is larger than the shortest distance, in the gravity direction, between the outer surfaces of the adjacent heat transfer tubes 10 in the second end portion 11n. In the first end portion 11m, the heat transfer tubes 10 may be arranged at different intervals in the gravity direction. In the second end portion 11n, the heat transfer tubes 10 may be arranged at different intervals in the gravity direction. In this specification, the interval between adjacent heat transfer tubes 10 means the shortest distance, in the gravity direction, between the outer surfaces of the heat transfer tubes 10.

As long as the shortest distance D1 is larger than the shortest distance D2, the shortest distance, in the gravity direction, between the outer surfaces of the adjacent heat transfer tubes 10 is not limited to a specific value, in each of the first heat transfer tube group 11a and the second heat transfer tube group 11b. As shown in FIG. 1, for example, the heat transfer tubes 10 are arranged at equal intervals in the gravity direction in the first heat transfer tube group 11a. In addition, the heat transfer tubes 10 are arranged at equal intervals in the gravity direction in the second heat transfer tube group 11b. The shortest distance, in the gravity direction, between the outer surfaces of heat transfer tubes 10 adjacent to each other in the same column of the first heat transfer tube group 11a is larger than the shortest distance, in the gravity direction, between the outer surfaces of heat transfer tubes 10 adjacent to each other in the same column of the second heat transfer tube group.

In the first heat transfer tube group 11a and the second heat transfer tube group 11b, for example, the heat transfer tubes 10 are arranged parallel to each other, and form a plurality of rows in the gravity direction. In the first heat transfer tube group 11a and the second heat transfer tube group 11b, for example, the heat transfer tubes 10 are arranged so as to form a square lattice, a rectangular lattice, or a parallelogram lattice in a plane (ZY plane) perpendicular to the longitudinal direction of the heat transfer tubes 10. Each heat transfer tube 10 is, for example, a tube made of copper or stainless steel. Each heat transfer tube 10 may have a groove in its inner surface or outer surface. In each of the first heat transfer tube group 11a and the second heat transfer tube group 11b, the heat transfer tubes 10 may have the same dimension and shape. Each of the first heat transfer tube group 11a and the second heat transfer tube group 11b may include a plurality of types of heat transfer tubes 10 having different dimensions and shapes.

Each of the first dripper 12a and the second dripper 12b is not limited to a specific configuration as long as it can drip the absorbent liquid. Each of the first dripper 12a and the second dripper 12b can be fabricated by, for example, welding components obtained by pressing stainless steel plates.

As shown in FIG. 1, for example, a heat exchange unit 5a including the absorber unit 1a and an evaporator unit 2 is provided. The evaporator unit 2 includes a first evaporator 23a and a second evaporator 23b. The first evaporator 23a generates a vapor-phase refrigerant to be supplied to the first absorber 13a. The second evaporator 23b generates a vapor-phase refrigerant to be supplied to the second absorber 13b.

The first evaporator 23a generates the vapor-phase refrigerant through heat exchange between a liquid-phase refrigerant and a heat medium. In addition, the second evaporator 23b generates a vapor-phase refrigerant through heat exchange between a liquid-phase refrigerant and a heat medium. The temperature of the heat medium supplied to the second evaporator 23b is higher than the temperature of the heat medium discharged from the first evaporator 23a, during the steady operation of the heat exchange unit 5a.

The arrangement of the first evaporator 23a and the second evaporator 23b in the evaporator unit 2 is not limited to a specific arrangement. As shown in FIG. 1, for example, the first evaporator 23a is disposed in the upper stage of the evaporator unit 2, and the second evaporator 23b is disposed in the lower stage of the evaporator unit 2, with reference to the gravity direction.

The heat exchange unit 5a is charged with a refrigerant and an absorbent liquid. The refrigerant is, for example, a chlorofluorocarbon refrigerant, such as hydrofluorocarbon (HFC) or a natural refrigerant, such as water or ammonia. The absorbent liquid is, for example, an aqueous solution of lithium bromide, or an ionic fluid.

As shown in FIG. 1, the heat exchange unit 5a includes, for example, a shell 30. The shell 30 has thermal insulation properties and pressure resistance. The liquid-phase refrigerant and the absorbent liquid are stored inside the shell 30. In addition, the vapor-phase refrigerant inside the shell 30 is isolated from the outside air, such as air at atmospheric pressure.

Each of the first evaporator 23a and the second evaporator 23b is, for example, a shell-and-tube heat exchanger. For example, in the case where a refrigerant, such as water, whose saturated vapor pressure at ordinary temperature (20° C.±15° C.) is a negative pressure is used, the water-level head of the liquid-phase refrigerant tends to greatly influence the evaporation pressure in a flooded shell-and-tube heat exchanger. Therefore, in the case where the refrigerant such as water is used, it is advantageous that each of the first evaporator 23a and the second evaporator 23b is a spraying or sprinkling type shell-and-tube heat exchanger.

As shown in FIG. 1, the first evaporator 23a includes, for example, a third heat transfer tube group 21a, and a third dripper 22a. The second evaporator 23b includes, for example, a fourth heat transfer tube group 21b, and a fourth dripper 22b. Each of the third heat transfer tube group 21a and the fourth heat transfer tube group 21b includes heat transfer tubes 20 arranged in rows and columns. In each of the third heat transfer tube group 21a and the fourth heat transfer tube group 21b, for example, the heat transfer tubes 20 are arranged parallel to each other, and form a plurality of rows in the gravity direction. In each of the third heat transfer tube group 21a and the fourth heat transfer tube group 21b, for example, the heat transfer tubes 20 are arranged so as to form a square lattice, a rectangular lattice, or a parallelogram lattice in a plane (ZY plane) perpendicular to the longitudinal direction of the heat transfer tubes 20. Each heat transfer tube 20 is, for example, a tube made of copper or stainless steel. Each heat transfer tube 20 may have a groove in its inner surface or outer surface.

The third dripper 22a drips a liquid-phase refrigerant toward the third heat transfer tube group 21a. The fourth dripper 22b drips the liquid-phase refrigerant toward the fourth heat transfer tube group 21b. Each of the third dripper 22a and the fourth dripper 22b is not limited to a specific configuration as long as it can drip the liquid-phase refrigerant. Each of the third dripper 22a and the fourth dripper 22b can be fabricated by, for example, welding components obtained by pressing stainless steel plates.

As shown in FIG. 1, the heat exchange unit 5a further includes a first supply path 16, a discharge path 17, and a pump 18. The first supply path 16 is a path for supplying the absorbent liquid into the absorber unit 1a. The first supply path 16 is formed of, for example, a tube having thermal insulation properties and pressure resistance.

The discharge path 17 is a path for discharging the absorbent liquid from the absorber unit 1a. The discharge path 17 is formed of, for example, a tube having thermal insulation properties and pressure resistance.

The pump 18 is disposed in, for example, the discharge path 17. The pump 18 is, for example, a dynamic canned pump. Owing to the operation of the pump 18, the absorbent liquid stored in the absorber unit 1a is pumped to pass through the discharge path 17.

As shown in FIG. 1, the heat exchange unit 5a further includes a second supply path 26, a circulation path 27, and a pump 28. The second supply path 26 is a path for supplying the liquid-phase refrigerant into the evaporator unit 2. The second supply path 26 is connected to, for example, the second evaporator 23b. The second supply path 26 is formed of, for example, a tube having thermal insulation properties and pressure resistance.

The circulation path 27 is connected to, for example, the second evaporator 23b. The circulation path 27 is formed of, for example, a tube having thermal insulation properties and pressure resistance.

The pump 28 pumps the liquid-phase refrigerant stored in the second evaporator 23b to allow the refrigerant to pass through the circulation path 27. The pump 28 is, for example, a dynamic canned pump. As shown in FIG. 1, the pump 28 is disposed in, for example, the circulation path 27. Owing to the operation of the pump 28, the liquid-phase refrigerant stored in the second evaporator 23b passes through the circulation path 27 and is guided to the third dripper 22a of the first evaporator 23a.

As shown in FIG. 1, the heat exchange unit 5a further includes, for example, a first eliminator 31, a second eliminator 32, a first vapor flow path 33, and a second vapor flow path 34. The first vapor flow path 33 is a path for guiding the vapor-phase refrigerant generated in the first evaporator 23a to the first absorber 13a. The first vapor flow path 33 allows the inside of the first evaporator 23a to communicate with the inside of the first absorber 13a. The second vapor flow path 34 is a path for guiding the vapor-phase refrigerant generated in the second evaporator 23b to the second absorber 13b. The second vapor flow path 34 allows the inside of the second evaporator 23b to communicate with the inside of the second absorber 13b. The first vapor flow path 33 and the second vapor flow path 34 are made of a metal material, such as steel, to have thermal insulation properties and pressure resistance.

Each of the first eliminator 31 and the second eliminator 32 is a vapor liquid separator, and prevents droplets of the liquid-phase refrigerant in the evaporator unit 2 from being dragged by the flow of the vapor-phase refrigerant and carried to the absorber unit 1a. The first eliminator 31 is disposed in the first vapor flow path 33. The second eliminator 32 is disposed in the second vapor flow path 34. Each of the first eliminator 31 and the second eliminator 32 can be fabricated by, for example, welding components obtained by pressing stainless steel plates.

### 1-2. Operation

As for the heat exchange unit 5a configured as above, its operations and functions will be described with reference to FIG. 1.

When the heat exchange unit 5a is not operated for a specific time period, such as at night, the internal temperature of the heat exchange unit 5a is almost equal to room temperature and uniform, and the internal pressure of the heat exchange unit 5a is uniform as well. For example, at a room temperature of 25° C., the internal temperature of the heat exchange unit 5a is also 25° C. and uniform. In use of the heat exchange unit 5a, a heat medium, such as water, that has absorbed heat from the outside of the heat exchange unit 5a flows inside the heat transfer tubes 20 of the third heat transfer tube group 21a and the fourth heat transfer tube group 21b. This heat medium flows into the fourth heat transfer tube group 21b at, for example, 12° C., passes through the fourth heat transfer tube group 21b, and flows into the third heat transfer tube group 21a. Meanwhile, a heat medium, such as water, that has dissipated heat to the outside of the heat exchange unit 5a flows inside the heat transfer tubes 10 of the first heat transfer tube group 11a and the second heat transfer tube group 11b in the absorber unit 1a. This heat medium flows into the second heat transfer tube group 11b at, for example, 32° C.

When the use of the heat exchange unit 5a is started, the liquid-phase refrigerant stored in the second evaporator 23b is firstly sucked by the pump 28, and the liquid-phase refrigerant is supplied to the third dripper 22a through the circulation path 27. Thus, the liquid-phase refrigerant is dripped from the third dripper 22a toward the third heat transfer tube group 21a. The liquid-phase refrigerant dripped toward the third heat transfer tube group 21a flows down while forming liquid films on the outer surfaces of the heat transfer tubes 20. During a time period when the liquid-phase refrigerant flows down the outer surfaces of the heat transfer tubes 20, the liquid-phase refrigerant takes heat from the heat medium such as water flowing in the heat transfer tubes 20, and evaporates, thereby generating a vapor-phase refrigerant. The liquid-phase refrigerant that has not evaporated is supplied to the fourth dripper 22b. The liquid-phase refrigerant supplied to the fourth dripper 22b is dripped from the fourth dripper 22b toward the fourth heat transfer tube group 21b. The liquid-phase refrigerant dripped toward the fourth heat transfer tube group 21b flows down while forming liquid films on the outer surfaces of the heat transfer tubes 20. During a time period when the liquid-phase refrigerant flows down the outer surfaces of the heat transfer tubes 20, the liquid-phase refrigerant takes heat from the heat medium such as water flowing in the heat transfer tubes 20, and evaporates, thereby generating a vapor-phase refrigerant. The liquid-phase refrigerant that has not evaporated is stored in a lower portion of the shell 30.

Next, the absorbent liquid is supplied to the absorber unit 1a through the first supply path 16. The absorbent liquid to be supplied to the absorber unit 1a has, for example, a temperature of about 50° C. and a solute concentration of about 63 mass %. The absorbent liquid supplied to the absorber unit 1a is stored in the first dripper 12a, and is dripped toward the first heat transfer tube group 11a. The dripped absorbent liquid absorbs the vapor-phase refrigerant generated in the first evaporator 23a, while flowing down the outer surfaces of the heat transfer tubes 10 in the first heat transfer tube group 11a. Thus, the absorbent liquid with the reduced solute concentration is stored in the second dripper 12b. The absorbent liquid stored in the second dripper 12b has, for example, a temperature of about 44° C. and a solute concentration of about 59 mass %. The absorbent liquid stored in the second dripper 12b is dripped toward the second heat transfer tube group 11b. The dripped absorbent liquid absorbs the vapor-phase refrigerant generated in the second evaporator 23b, while flowing down the outer surfaces of the heat transfer tubes in the second heat transfer tube group 11b. Thus, the absorbent liquid with the further reduced solute concentration is stored in the lower portion of the shell 30. The absorbent liquid stored in the lower portion of the shell 30 is pumped by the pump 18 to be discharged to the outside of the absorber unit 1a through the discharge path 17. The absorbent liquid to be discharged has, for example, a temperature of about 37° C. and a solute concentration of about 55 mass %.

When the absorbent liquid flows down the outer surfaces of the heat transfer tubes of the first heat transfer tube group 11a or the second heat transfer tube group 11b, the vapor-phase refrigerant generated in the first evaporator 23a or the second evaporator 23b is absorbed by the absorbent liquid. Absorption of the vapor-phase refrigerant by the absorbent liquid increases the temperature of the absorbent liquid, but at the same time, the absorbent liquid is cooled by the heat medium flowing inside the heat transfer tubes 10 of the first heat transfer tube group 11a or the second heat transfer tube group 11b. Therefore, absorption of the vapor-phase refrigerant by the absorbent liquid in the supercooled state continuously occurs, so that the internal pressure of the heat exchange unit 5a decreases. Thus, the liquid-phase refrigerant, which flows down the outer surfaces of the heat transfer tubes 20 of the third heat transfer tube group 21a and the fourth heat transfer tube group 21b, evaporates. Evaporation of the liquid-phase refrigerant decreases the temperature of the liquid-phase refrigerant, but at the same time, the liquid-phase refrigerant is heated by the heat medium flowing inside the heat transfer tubes 20 of the third heat transfer tube group 21a and the fourth heat transfer tube group 21b. Therefore, evaporation of the liquid-phase refrigerant continuously occurs, the internal pressure of the heat exchange unit 5a is kept within a predetermined range, and the internal state of the heat exchange unit 5a becomes a steady state. In the steady state, the temperature of the heat medium decreases from 12° C. to about 9.75° C. in the fourth heat transfer tube group 21b. In addition, the temperature of the heat medium decreases from about 9.75° C. to about 7° C. in the third heat transfer tube group 21a. As a result, in the steady state, the liquid-phase refrigerant stored in the second evaporator 23b has a temperature of about 7.6° C., and the vapor-phase refrigerant in the second evaporator 23b has a pressure of about 1044 Pa that is the saturated vapor pressure of the liquid-phase refrigerant at about 7.6° C. Therefore, the vapor-phase refrigerant in the second evaporator 23b has a density of about 0.00806 kg/m³. Meanwhile, in the steady state, the liquid-phase refrigerant stored in the first evaporator 23a has a temperature of about 6.1° C., and the vapor-phase refrigerant in the first evaporator 23a has a pressure of about 942 Pa that is the saturated vapor pressure of the liquid-phase refrigerant at about 6.1° C. Therefore, the vapor-phase refrigerant in the first evaporator 23a has a density of about 0.00731 kg/m³.

In the steady state, the temperature of the heat medium flowing inside the heat transfer tubes 10 of the second heat transfer tube group 11b increases from 32° C. to 34.25° C. In addition, the temperature of the heat medium flowing inside the heat transfer tubes 10 of the first heat transfer tube group 11a increases from 34.25° C. to 36.5° C. In the steady state, the absorbent liquid, which is stored in the first dripper 12a and is dripped toward the first heat transfer tube group 11a, has a temperature of 50° C. Meanwhile, in the steady state, the absorbent liquid, which is cooled by the heat medium flowing inside the heat transfer tubes 10 of the first heat transfer tube group 11a, is stored in the second dripper 12b, and is dripped toward the second heat transfer tube group 11b, has a temperature of 44° C. The absorbent liquid, which is dripped toward the second heat transfer tube group 11b, is cooled by the heat medium flowing inside the heat transfer tubes 10 of the first heat transfer tube group 11b, and is stored in the lower portion of the shell 30, has a temperature of 37° C. Therefore, the LMTD regarding heat exchange between the absorbent liquid and the heat medium in the second absorber 13b is about 7.1 K. Meanwhile, the LMTD regarding heat exchange between the absorbent liquid and the heat medium in the first absorber 13a is about 11.5 K.

An amount of heat dissipation Q_{A} to the heat medium flowing inside the heat transfer tubes 10 of the first heat transfer tube group 11a or the second heat transfer tube group 11b can be calculated according to Q_{A}=qₘ·ΔH=K·A·LMTD. Here, qₘ is a mass flow rate [kg/s] of the vapor-phase refrigerant that is generated by the evaporator and absorbed by the absorber, and ΔH is an amount of enthalpy change between the vapor-phase refrigerant and the absorbent liquid in the first absorber 13a or the second absorber 13b. In addition, K is a heat transfer coefficient [W/(m²·K)] of the first heat transfer tube group 11a or the second heat transfer tube group 11b, and A is an area [m²] of the outer surfaces of the heat transfer tubes 10 in the first heat transfer tube group 11a or the second heat transfer tube group 11b.

The amount of enthalpy change ΔH between the vapor-phase refrigerant and the absorbent liquid in the first absorber 13a or the second absorber 13b is expressed by ΔH=H_{R}+{Hₛ₁·W₂/(W₁−W₂)}−Hₛ₂·W₁/(W₁−W₂). Here, H_{R} is an enthalpy [kJ] of the vapor-phase refrigerant, and Hₛ₁ is an enthalpy [kJ] of the absorbent liquid having a high concentration before being diluted due to absorption of the vapor-phase refrigerant. Hₛ₂ is an enthalpy [kJ] of the absorbent liquid having a low concentration after having been diluted due to absorption of the vapor-phase refrigerant. W₁ is a mass concentration [%] of the solute of the high-concentration absorbent liquid, and W₂ is a mass concentration [%] of the low-concentration absorbent liquid.

A mass flow rate qₘ of the vapor-phase refrigerant, which is generated by the evaporator and absorbed by the first absorber 13a or the second absorber 13b, is expressed by qₘ=qᵥ·ρ=u·N_{R}·S·L·ρ. Here, qᵥ is a volume flow rate [m³/s] of the vapor-phase refrigerant, p is a density [kg/m³] of the vapor-phase refrigerant, and u is a velocity [m/s] at which the vapor-phase refrigerant passes between adjacent heat transfer tubes 10. In addition, N_{R} is the number of rows of the heat transfer tubes 10 in the first heat transfer tube group 11a or the second heat transfer tube group 11b, L is a length [m] of each heat transfer tube 10, and s is a shortest distance [m], in the gravity direction, between the outer surfaces of a pair of heat transfer tubes 10 adjacent to each other in the gravity direction. The area A [m²] of the heat transfer tubes 10 in the first heat transfer tube group 11a or the second heat transfer tube group 11b can be expressed by, for example, A=π·d·L·N_{R}·N_{C}. Here, d is an outer diameter [m] of each heat transfer tube 10, and N_{C} is the number of columns of the heat transfer tubes 10.

A relational expression, u=K·LMTD·π·d·N_{C}/(ΔH·ρ·s), can be derived from the above expressions. In this relational expression, IT is a constant, and it is assumed that the first heat transfer tube group 11a and the second heat transfer tube group 11b have the same heat transfer coefficient K [W/(m²·K)], and the same outer diameter d [m] of each heat transfer tube 10. In addition, it is assumed that the first heat transfer tube group 11a and the second heat transfer tube group 11b have the same number of columns of the heat transfer tubes 10. From the viewpoint of restrictions on the shell size, it is assumed that the low pressure side absorber and the high pressure side absorber in the two-stage evaporation/absorption structure are designed to have the same number of columns of heat transfer tubes in heat transfer tube groups. It is assumed that the first absorber 13a and the second absorber 13b have substantially the same amount of enthalpy change ΔH in the steady state. In this case, a flow velocity u_{L} of the vapor-phase refrigerant between adjacent heat transfer tubes 10 in the first heat transfer tube group 11a and a flow velocity u_{H} of the vapor-phase refrigerant between adjacent heat transfer tubes 10 in the second heat transfer tube group 11b have a relationship of u_{L}/u_{H}=(LMTD_{L}·ρ_{H}·s_{H})/(LMTD_{H}·ρ_{L}·s_{L}). In this relational expression, the suffix L indicates that the value relates to the first absorber 13a, and the suffix H indicates that the value relates to the second absorber 13b. In the steady state, if the shortest distance s_{L} is equal to the shortest distance s_{H}, the flow velocity u_{L} of the vapor-phase refrigerant between adjacent heat transfer tubes 10 in the first heat transfer tube group 11a is about 1.78 times the flow velocity u_{H} of the vapor-phase refrigerant between adjacent heat transfer tubes 10 in the second heat transfer tube group 11b.

### 1-3. Effects, Etc

As described above, in the present embodiment, the absorber unit 1a for an absorption refrigerator includes the first absorber 13a and the second absorber 13b. The first absorber 13a includes the first heat transfer tube group 11a and the first dripper 12a. The first heat transfer tube group 11a includes the heat transfer tubes 10 arranged in rows and columns. The first dripper 12a drips the absorbent liquid toward the first heat transfer tube group 11a. The first absorber 13a allows the absorbent liquid dripped by the first dripper 12a to absorb the vapor-phase refrigerant supplied to one end, in the column direction, of the first heat transfer tube group 11a. The second absorber 13b includes the second heat transfer tube group 11b and the second dripper 12b. The second heat transfer tube group 11b includes the heat transfer tubes 10 arranged in rows and columns. The second dripper 12b drips the absorbent liquid toward the second heat transfer tube group 11b. The second absorber 13b allows the absorbent liquid dripped by the second dripper 12b to absorb the vapor-phase refrigerant supplied to one end, in the column direction, of the second heat transfer tube group 11b. The absorbent liquid, which has been dripped by the first dripper 12a and has flowed down the first heat transfer tube group 11a, is supplied to the second absorber 13b and then is dripped by the second dripper 12b. The absorbent liquid, which has been dripped by the second dripper 12b and has flowed down the second heat transfer tube group 11b, is discharged to the outside of the second absorber 13b.

The first heat transfer tube group 11a has the first end portion 11m. The first end portion 11m includes the heat transfer tubes 10 forming a plurality of rows at the one end, in the column direction, of the first heat transfer tube group 11a. The second heat transfer tube group 11b has the second end portion 11n. The second end portion 11n includes the heat transfer tubes 10 forming a plurality of rows at the one end, in the column direction, of the second heat transfer tube group 11b. In the first end portion 11m and the second end portion 11n, the shortest distance D1 is larger than the shortest distance D2. The shortest distance D1 is a shortest distance, in the gravity direction, between the outer surfaces of a specific pair of adjacent heat transfer tubes 10 in the first end portion 11m. The shortest distance D2 is a shortest distance, in the gravity direction, between the outer surfaces of a pair of heat transfer tubes 10 forming, in the second end portion 11n, rows corresponding to the specific pair of heat transfer tubes 10.

Thus, the flow velocity of the vapor-phase refrigerant between the specific pair of adjacent heat transfer tubes 10 in the first end portion 11m is less prone to be increased. For example, the shortest distance D1 is adjusted to be 1.78 times the shortest distance D2. In this case, the flow velocity of the vapor-phase refrigerant between the specific pair of heat transfer tubes 10 with the shortest distance D1 can be made substantially equal to the flow velocity of the vapor-phase refrigerant between the pair of heat transfer tubes 10 forming, in the second end portion 11n, the rows corresponding to the specific pair of heat transfer tubes 10. Therefore, the absorbent liquid is less prone to be blown off by the vapor-phase refrigerant between the specific pair of heat transfer tubes 10 with the shortest distance D1, thereby inhibiting the state in which the heat transfer tubes 10 are not wet with the absorbent liquid. The vapor-phase refrigerant first passes between adjacent heat transfer tubes 10 in the first end portion 11m of the first heat transfer tube group 11a. Therefore, the shortest distance D1 between the specific pair of heat transfer tubes 10 in the first end portion 11m being larger than the shortest distance D2 is effective in terms of inhibiting the state in which the heat transfer tubes 10 are not wet with the absorbent liquid.

As in the present embodiment, the first absorber 13a may face the first eliminator 31. In addition, in the first heat transfer tube group 11a, the first end portion 11m may be a column closest to the first eliminator 31. The vapor-phase refrigerant passes through the first eliminator 31 and is guided to the first absorber 13a. The specific pair of heat transfer tubes 10 with the shortest distance D1 being present in the first end portion 11m that is the column closest to the first eliminator 31 in the first heat transfer tube group 11a, is effective in terms of inhibiting the state in which the heat transfer tubes 10 are not wet with the absorbent liquid.

As in the present embodiment, the specific pair of heat transfer tubes 10 with the shortest distance D1 may include the heat transfer tubes 10 arranged above the center, based on the number of rows, of the first end portion 11m. Thus, it is possible to inhibit the situation that the heat transfer tubes 10 arranged above the center, based on the number of rows, of the first end portion 11m are not wet with the absorbent liquid and thereby the heat transfer tubes 10 arranged beneath the heat transfer tubes 10 are also not wet with the absorbent liquid. This is because the absorbent liquid flows down from the upper heat transfer tubes 10 toward the lower heat transfer tubes 10 in the first heat transfer tube group 11a.

As in the present embodiment, the specific pair of heat transfer tubes 10 with the shortest distance D1 may include the heat transfer tube 10 in the uppermost row in the first end portion 11m. Thus, it is possible to inhibit the situation that the heat transfer tube 10 in the uppermost row in the first end portion 11m is not wet with the absorbent liquid and thereby the heat transfer tubes 10 beneath the uppermost heat transfer tube 10 are also not wet with the absorbent liquid.

As in the present embodiment, the heat transfer tubes 10 in the first end portion 11m may be arranged at equal intervals in the gravity direction, and the heat transfer tubes in the second end portion 11n may be arranged at equal intervals in the gravity direction. In addition, the shortest distance, in the gravity direction, between the outer surfaces of the adjacent heat transfer tubes 10 in the first end portion 11m may be larger than the shortest distance, in the gravity direction, between the outer surfaces of the adjacent heat transfer tubes 10 in the second end portion 11n. Thus, in the entire first end portion 11m, the flow velocity of the vapor-phase refrigerant between the adjacent heat transfer tubes 10 is less prone to be increased, thereby inhibiting the state in which the heat transfer tubes 10 are not wet with the absorbent liquid.

As in the present embodiment, the heat transfer tubes 10 in the first heat transfer tube group 11a may be arranged at equal intervals in the gravity direction, and the heat transfer tubes 10 in the second heat transfer tube group 11b may be arranged at equal intervals in the gravity direction. In addition, the shortest distance, in the gravity direction, between the outer surfaces of heat transfer tubes 10 adjacent to each other in the same column of the first heat transfer tube group 11a may be larger than the shortest distance, in the gravity direction, between the outer surfaces of heat transfer tubes 10 adjacent to each other in the same column of the second heat transfer tube group 11b.

As in the present embodiment, the heat exchange unit 5a including the absorber unit 1a, the first evaporator 23a, and the second evaporator 23b may be provided. In this case, the first evaporator 23a may generate the vapor-phase refrigerant to be supplied to the first absorber 13a. In addition, the second evaporator 23b may generate the vapor-phase refrigerant to be supplied to the second absorber 13b. This allows the absorption refrigerator including the heat exchange unit 5a to have a high COP.

As in the present embodiment, the first evaporator 23a may generate the vapor-phase refrigerant through heat exchange between the liquid-phase refrigerant and the heat medium, and the second evaporator 23b may generate the vapor-phase refrigerant through heat exchange between the liquid-phase refrigerant and the heat medium. In addition, the temperature of the heat medium supplied to the second evaporator 23b may be higher than the temperature of the heat medium discharged from the first evaporator 23a. In this case, the density of the vapor-phase refrigerant supplied to the first absorber 13a tends to be lower than the density of the vapor-phase refrigerant supplied to the second absorber 13b. However, since the shortest distance D1 is larger than the shortest distance D2, the state that the heat transfer tubes 10 are not wet with the absorbent liquid in the first heat transfer tube group 11a is easily inhibited.

### Embodiment 2

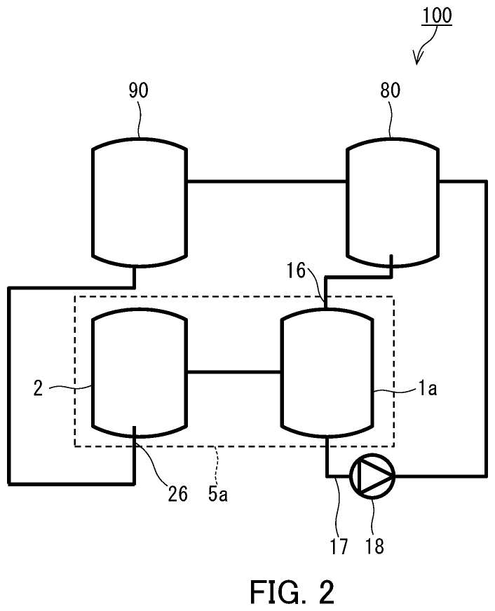

Hereinafter, Embodiment 2 will be described below with reference to FIG. 2.

### 2-1. Configuration

As shown in FIG. 2, an absorption refrigerator 100 is provided with, for example, a heat exchange unit 5a. The absorption refrigerator 100 further includes, for example, a regenerator 80 and a condenser 90. The absorption refrigerator 100 is, for example, an absorption refrigerator of a single-effect cycle. The absorption refrigerator 100 may be an absorption refrigerator of a double-effect cycle or a triple-effect cycle. If a gas burner is used as a heat source for the regenerator 80, the absorption refrigerator 100 may be a gas chiller.

### 2-2. Operation

As for the absorption refrigerator 100 configured as above, its operations and functions will be described below. The absorbent liquid stored in the absorber unit 1a is guided to the regenerator 80 through the discharge path 17. In the regenerator 80, the absorbent liquid is heated to increase the solute concentration. The absorbent liquid with the increased solute concentration is guided to the absorber unit 1a through the first supply path 16. Meanwhile, heating of the absorbent liquid in the regenerator 80 generates a vapor-phase refrigerant. This vapor-phase refrigerant is guided to the condenser 90, and is cooled to be condensed in the condenser 90, thereby generating a liquid-phase refrigerant. The liquid-phase refrigerant is, for example, depressurized and then is guided to the evaporator unit 2 through the second supply path 26.

### 2-3. Effects

As described above, in the present embodiment, the absorption refrigerator 100 includes the heat exchange unit 5a. This inhibits the state in which the heat transfer tubes 10 are not wet with the absorbent liquid in the absorber unit 1a in the heat exchange unit 5a, and heat exchange performance in the absorber unit 1a can be easily kept high. This allows the absorption refrigerator 100 to easily achieve high energy saving performance, and allows the absorption refrigerator 100 to have a high coefficient of performance (COP).

As described above, Embodiments 1 and 2 have been described as exemplary techniques disclosed in the present application. However, the technique according to the present disclosure is not limited to these, and is also applicable to embodiments with modifications, replacements, additions, omissions, and the like.

### INDUSTRIAL APPLICABILITY

The present disclosure is applicable to absorption refrigerators that are adapted to central air conditioners for buildings, chillers for process cooling, and the like.

1. An absorber unit for an absorption refrigerator, comprising:
a first absorber being provided with a first heat transfer tube group including a plurality of heat transfer tubes arranged in rows and columns, and a first dripper configured to drip an absorbent liquid toward the first heat transfer tube group, the first absorber allowing the absorbent liquid dripped by the first dripper to absorb a vapor-phase refrigerant that is supplied to one end, in a column direction, of the first heat transfer tube group; and
a second absorber being provided with a second heat transfer tube group including a plurality of heat transfer tubes arranged in rows and columns, and a second dripper configured to drip an absorbent liquid toward the second heat transfer tube group, the second absorber allowing the absorbent liquid dripped by the second dripper to absorb a vapor-phase refrigerant that is supplied to one end, in the column direction, of the second heat transfer tube group, wherein
the absorbent liquid that has been dripped by the first dripper and has flowed down the first heat transfer tube group is supplied to the second absorber and then is dripped by the second dripper,
the absorbent liquid that has been dripped by the second dripper and has flowed down the second heat transfer tube group is discharged to the outside of the second absorber,
the first heat transfer tube group has a first end portion that includes the heat transfer tubes forming the rows at the one end, in the column direction, of the first heat transfer tube group,
the second heat transfer tube group has a second end portion that includes the heat transfer tubes forming the rows at the one end, in the column direction, of the second heat transfer tube group, and
a shortest distance, in a gravity direction, between outer surfaces of a specific pair of the heat transfer tubes adjacent to each other in the first end portion is larger than a shortest distance, in the gravity direction, between outer surfaces of a pair of the heat transfer tubes forming, in the second end portion, rows corresponding to the specific pair of the heat transfer tubes.

2. The absorber unit for an absorption refrigerator according to claim 1, wherein
the specific pair of heat transfer tubes includes a heat transfer tube that is arranged above a center, based on the number of rows, of the first end portion.

3. The absorber unit for an absorption refrigerator according to claim 1, wherein
the specific pair of heat transfer tubes includes a heat transfer tube in an uppermost row in the first end portion.

4. The absorber unit for an absorption refrigerator according to claim 1, wherein
in the first end portion, the heat transfer tubes are arranged at equal intervals in the gravity direction,
in the second end portion, the heat transfer tubes are arranged at equal intervals in the gravity direction, and
a shortest distance, in the gravity direction, between the outer surfaces of the heat transfer tubes adjacent to each other in the first end portion is larger than a shortest distance, in the gravity direction, between the outer surfaces of the heat transfer tubes adjacent to each other in the second end portion.

5. The absorber unit for an absorption refrigerator according to claim 1, wherein
in the first heat transfer tube group, the heat transfer tubes are arranged at equal intervals in the gravity direction,
in the second heat transfer tube group, the heat transfer tubes are arranged at equal intervals in the gravity direction, and
a shortest distance, in the gravity direction, between the outer surfaces of the heat transfer tubes adjacent to each other in the same column of the first heat transfer tube group is larger than a shortest distance, in the gravity direction, between the outer surfaces of the heat transfer tubes adjacent to each other in the same column of the second heat transfer tube group.

6. A heat exchange unit comprising:
the absorber unit according to claim 1;
a first evaporator configured to generate the vapor-phase refrigerant to be supplied to the first absorber; and
a second evaporator configured to generate the vapor-phase refrigerant to be supplied to the second absorber.

7. The heat exchange unit according to claim 6, wherein
the first evaporator generates the vapor-phase refrigerant through heat exchange between a liquid-phase refrigerant and a heat medium,
the second evaporator generates the vapor-phase refrigerant through heat exchange between the liquid-phase refrigerant and the heat medium, and
the heat medium supplied to the second evaporator has a temperature higher than that of the heat medium discharged from the first evaporator.

8. An absorption refrigerator comprising the heat exchange unit according to claim 6.
